(19) United States
(12) Patent Application Publication
(10) Pub. No.: US 2024/0300348 A1
(43) Pub. Date: Sep. 12, 2024

(54) Apparatus and Method for Enhancing Battery Life

(71) Applicant: Global EV Technology, Inc., Temecula, CA (US)

(72) Inventor: Lawrence J. Hardge, Beebe, AR (US)

(21) Appl. No.: 18/431,851

(22) Filed: Feb. 2, 2024

Related U.S. Application Data
(60) Provisional application No. 63/451,181, filed on Mar. 9, 2023.

(51) Int. Cl. B60L 53/22; B60L 1/00; B60L 58/16

(52) U.S. Cl. CPC B60L 53/22; B60L 1/20; B60L 58/16; B60L 2210/30

(57) ABSTRACT

A system for increasing the output of electrical motors by enhancing the life of batteries powering the electrical motors, including routing regenerative energy through a supplemental inverter before returning it to the battery, or possibly also routing the regenerative energy through a junction box and/or an auxiliary battery before returning it to the primary battery.

### CROSS REFERENCE TO RELATED APPLICATIONS

This utility patent application claims the priority benefit of the filing date of U.S. Provisional Application No. 63/451,181 filed 9 Mar. 2023.

### FIELD OF THE INVENTION

The present invention relates to systems for increasing the output of electrical motors by enhancing the life of batteries powering the electrical motors. More particularly, the invention disclosed herein relates to improvements to the utilization of battery power electricity, and the storage of battery power electricity. The primary field is electrically powered vehicles, although the system disclosed herein may be applicable to any field wherein an electrical motor and regenerative energy are involved.

### SUMMARY OF THE INVENTION

Disclosed herein is an energy management system that includes cabling and at least one inverter (possibly in addition to any inverter installed on the vehicle by the manufacture). This system does not alter the mechanical functioning of the vehicle, but supplements (and works in conjunction with) existing energy utilization infrastructure. The inverter may be a separate component, or it may be a sub-component of another component (such as, for example, being housed within a junction box or controller unit housing). The inverter may accomplish the standard function of converting DC power to AC power, or it may accomplish a rectifying function of converting DC power to AC power.

The cabling is always electrically conductive cabling, with sufficient thickness and protective insulation to safely withstand (and transport) the current “load” expected to pass along it, and to perform its energy management functions of the system.

The battery output and additional electricity demands of the motor and performance needs of the vehicle may make it necessary to enlarge the conversion capacity of the inverter and/or the thickness of all or some of the cabling.

The energy management system essentially processes electrical energy and eventually delivers it to the primary battery, often called a “traction battery pack”. In some instances, the energy management system routes electrical energy through the auxiliary battery (often a plurality of batteries connected in a circuit with a common input terminal and output terminal), before returning the energy to the primary battery. Such continuous processing constantly recharges the primary battery, and extends the life of the primary battery. Ideally the vehicle has a system for generating regenerative energy (“regen energy”), such as a regenerative braking system, in which case the energy management system receives such regen energy and processes it through the inverter for return to the primary battery. If the vehicle has any auxiliary battery, ideally the energy management system processes the regen energy through the auxiliary battery en route to the auxiliary before being routed to the primary battery. Such processing also takes the load off the electrical system, eliminating or greatly reducing the prospects for overheating.

In general, the invention disclosed herein includes (comprises or has) improvements to processing of regen energy, including routing regen energy through an inverter and improving cabling and the arrangement of cabling for battery storage systems.

One primary benefit of the disclosed invention is that a typical battery supplying electricity to an electrical motor is utilized more efficiently, and preserved better.

Another benefit of the disclosed invention is that auxiliary batteries are enabled to store electricity better and supply it to the primary battery for longer life, without becoming depleted.

These and other aspects of the disclosed subject matter, as well as additional novel features, will be apparent from the description provided herein. The intent of this summary is not to be a comprehensive description of the subject matter, but rather to provide a short overview of some of the subject matter's functionality. Other systems, methods, features and advantages herein provided will become apparent to one with skill in the art upon examination of the accompanying Figures and detailed description. It is intended that all such additional systems, methods, features and advantages that are included within this description, be within the scope of any claims filed now or later.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings.

FIG. 1 is a schematic sketch of another representative sample of the disclosed system, such as for a Club Car Precedent 4-seat golf cart, or for a Polaris GEM e6 6-seat shuttle vehicle.

FIG. 2 is a schematic sketch of another representative sample of the disclosed system, such as for a Chevrolet Bolt electric passenger vehicle or for a Mullens Automotive Mullen ONE Class 1 urban delivery cargo van.

FIG. 3 is a schematic sketch of another representative sample of a portion of the disclosed apparatus, especially the cabling and connection configuration.

These drawings illustrate certain details of certain embodiments. However, the invention disclosed herein is not limited to only the embodiments so illustrated. The invention disclosed herein may have equally effective or legally equivalent embodiments.

### DETAILED DESCRIPTION OF THE INVENTION

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising”, or “includes” and/or “including”, or “have” or “having”, when used in this specification, specify the presence of stated features, regions, integers, steps, operations, elements and/or components, but do not preclude the presence or addition of one or more other features, regions, integers, steps, operations, elements, components and/or groups thereof.

For the sake of simplicity and to give the claims of this patent application the broadest interpretation and construction possible, the conjunctive “and” may also be taken to include the disjunctive “or,” and vice versa, whenever necessary to give the claims of this patent application the broadest interpretation and construction possible. Likewise, when the plural form is used, it may be taken to include the singular form, and vice versa.

It will be understood that, although the terms first, second, third, etc. may be used herein to describe various elements, these elements should not be limited by these terms. These terms are only used to distinguish one element from another element. Likewise, synonyms for the same element, term or concept may be used only to distinguish one similar element from another, unless the context clearly indicates otherwise.

A “battery” may comprise a single entity, or a plurality of batteries or battery cells comprising a portion of an electrical circuit and often sharing a common input terminal and/or output terminal leading to other components or resources.

Typically a single “cable” includes at least two separately insulated and/or shielded sub-cables such as are commonly attached to a positive and negative terminal, plus any necessary grounding wire. As used herein, “cable” may refer to only one of said sub-cables at a time. For example if the identified cable connects an OEM controller to a battery, the context of the reference may indicate whether the connection is for transporting electrical current in one direction or the other direction.

The term “convert” or derivative thereof includes either conversion of alternating current (“AC”) electricity into direct current (“DC”) electricity (sometimes called rectification) or vice versa; such conversion may also include DC-to-DC conversion, from high voltage to lower voltage or vice versa.

The term “OEM controller” means the controller which was installed at the time of manufacturing or subsequently replaced to perform the functions of the controller installed at the time of manufacture; it may include associated functional components or sub-components such as an inverter, rectifier or DC-to-DC converter. The “supplemental inverter” is installed to perform the supplemental conversion functions of the energy management system disclosed herein; but to the extent that the OEM controller is modified or used in a different manner or direction to perform the supplemental conversion functions, the OEM controller qualifies as a supplemental inverter as well.

The terms “input terminal” and “output terminal” refer to the access point for the flow of electricity at one point in time but not necessarily at all times; those terms do not necessarily refer to separate and distinct physical pathways or access location points. In some instances or contexts, there may be a single physical connection point for cabling capable of accomplishing both input and output functions. In other instances, multiple connection points may (depending upon the moment in time) function as either an input terminal or an output terminal.

The disclosure herein is not limited by construction materials to the extent that other materials satisfy the structural and/or functional requirements. For example, any material may be used so long as it satisfies the functional and structural requirements for which it is being used. Likewise, the disclosed invention is not limited by any construction process or method.

A device or system that is configured in a certain way is configured in at least that way, but it can also be configured in other ways than those specifically described so long as the system enables the electricity producing, collecting, processing, transporting and storing functionality disclosed.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

The feature or features of one embodiment may be applied to or found in other embodiments, even though not described or illustrated, unless expressly prohibited by this disclosure or the nature of the embodiment or feature(s).

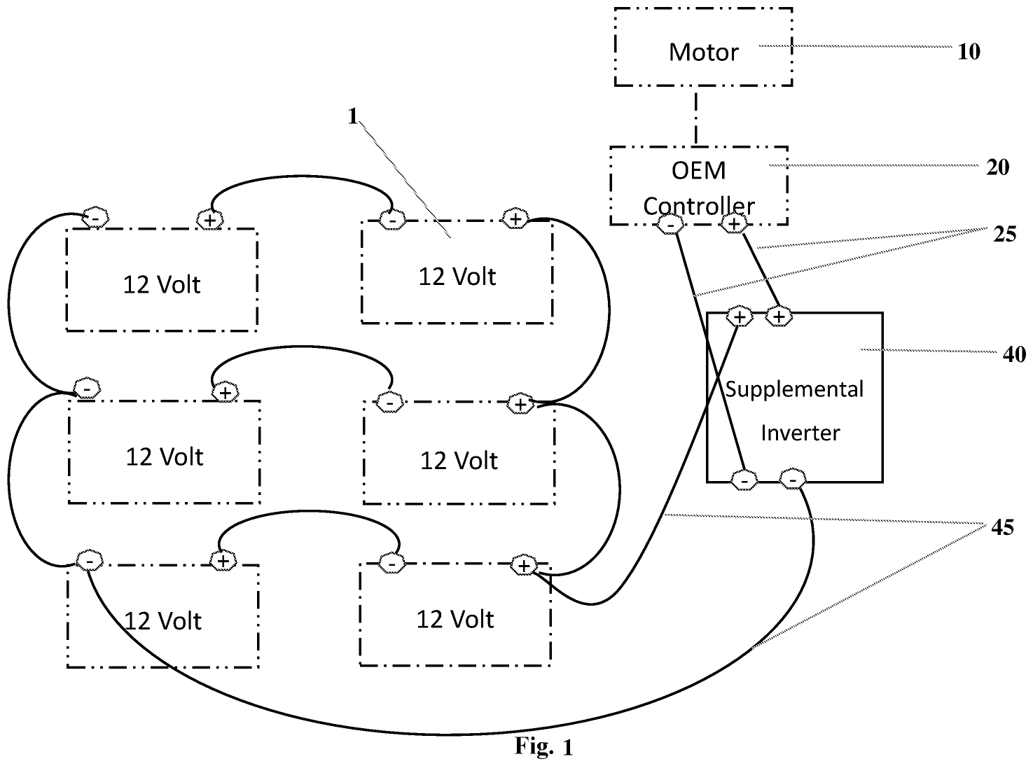

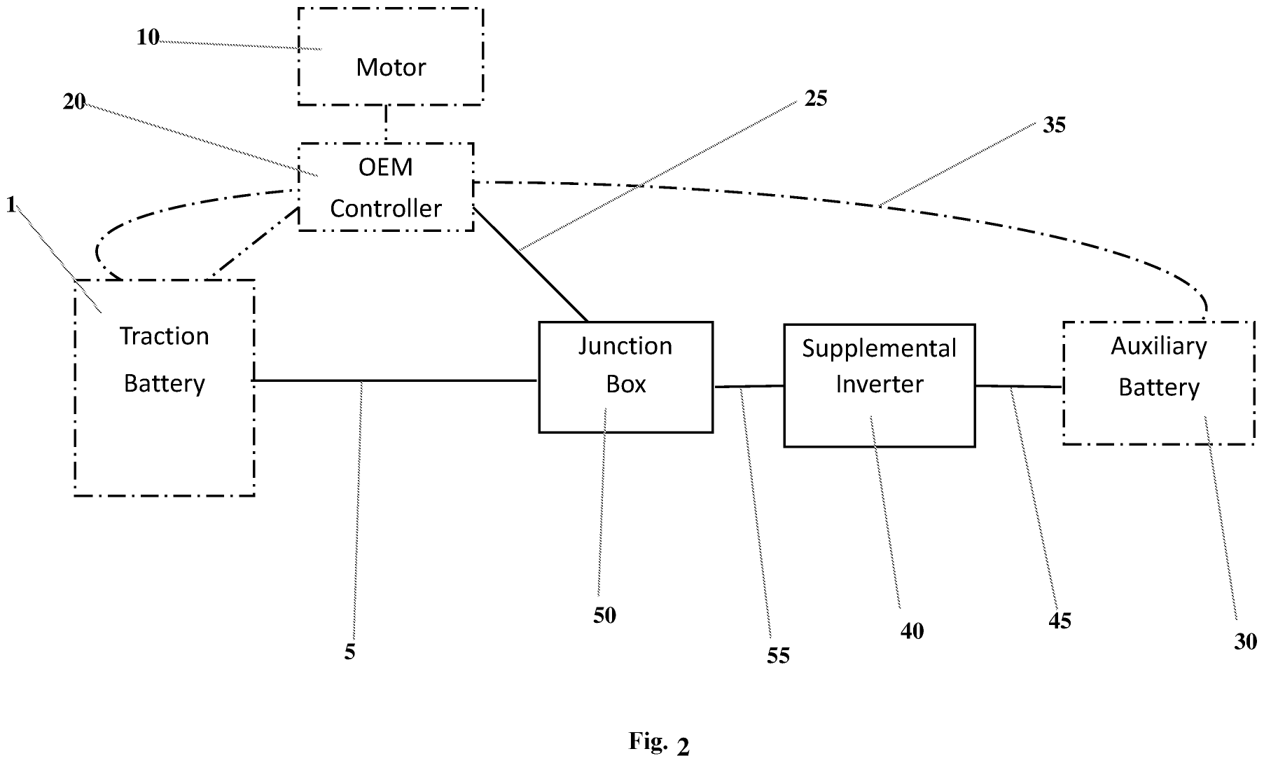

In its simplest form, the energy management system includes electrically conductive cabling transporting regen energy from the motor to and through a supplemental inverter before routing it to replenish the battery. FIG. 1 illustrates a representative example of such a system, often found on small electric vehicles such as golf carts. FIG. 2 illustrates another representative example of such a system, often found on electric vehicles such as a Chevrolet Bolt. The inverter may be that which was installed at the time of manufacturing (“OEM”), if that OEM controller has the conversion capabilities to perform the additional conversion function set forth herein. Alternatively, the inverter may be an additional inverter configured with the conversion capabilities and performance characteristics optimized to perform the additional conversion function set forth herein.

In systems having both a primary first battery (powering the motor) and a second auxiliary battery (powering non-motor electrical aspects of the vehicle), the energy management system may comprise electrically conductive cabling transporting regen energy from the OEM controller to and through the inverter for delivery to an auxiliary battery before the energy is routed to replenish the primary battery. The capabilities of the inverter to convert electrical current from one type to another (AC to DC, or vice versa) may be optimized to satisfy the energy needs of the motor and/or the performance needs of the vehicle. The physical specifics and performance characteristics of each of the cables may likewise be optimized, for the same reasons. When needed, the system may further include a junction box enabling the use of cables along the circuitry that have differing thicknesses (or connector thicknesses) and/or to combine electrical currents. Typically a junction box will include at least one set of electrically connected input and output terminals, and will be available for connection anywhere along the electrical circuitry needing a transitioning from a cable of one thickness to a cable of another thickness; the junction box may also include a plurality of electrically connected input terminals, where a combination of electrical currents is desired.

In one general embodiment, the energy management system disclosed herein, operating in conjunction with existing energy utilization infrastructure, comprises (includes) a complete electrical circuit including a primary battery (providing electricity to the electric motor), an inverter, and auxiliary batteries primarily providing energy for the non-motor electrical aspects of the vehicle. The primary battery may be of the type commonly supplying electricity to the electrical motor to which it is connected (AC motor or DC motor), typically having the standard positive (+) and negative (−) terminals for the entry and exit of electricity (electrons). The inverter may be of the type commonly used to convert alternating current (AC) to direct current (DC), or vice versa, depending upon the regen energy type and the needs of the battery receiving the regen energy. The auxiliary batteries may be of the type commonly storing electricity for non-motor use, typically having the standard positive (+) and negative (−) terminals. A battery may comprise a plurality of batteries or battery cells, often sharing a common input terminal and/or output terminal.

The system may also include a junction housing or box enabling transitioning of circuit cabling from one thickness to another en route between circuit components, or when at a plurality of electrically connected input terminals is needed such as when combination of electrical currents is desired. For example, the junction box includes at least one input terminal for connection with the output cable of the primary battery; and within that junction is an electrically connected output terminal capable of accepting connection with an output cable of the junction box having a thickness different from that of the input cable to the junction box. The junction box may have a plurality of such pairs of input terminals, enabling connections with other circuit components such as the OEM controller. The junction box may also house the inverter; alternatively, the inverter may house the junction infrastructure enabling the adjustment of cable thickness between the primary battery and the other circuitry component(s) connected to the inverter. Often, the cables connecting the primary first battery to the second auxiliary battery will need to be of thicker gauge, to safely satisfy the demands of the current expected to flow from the primary battery or vice versa.

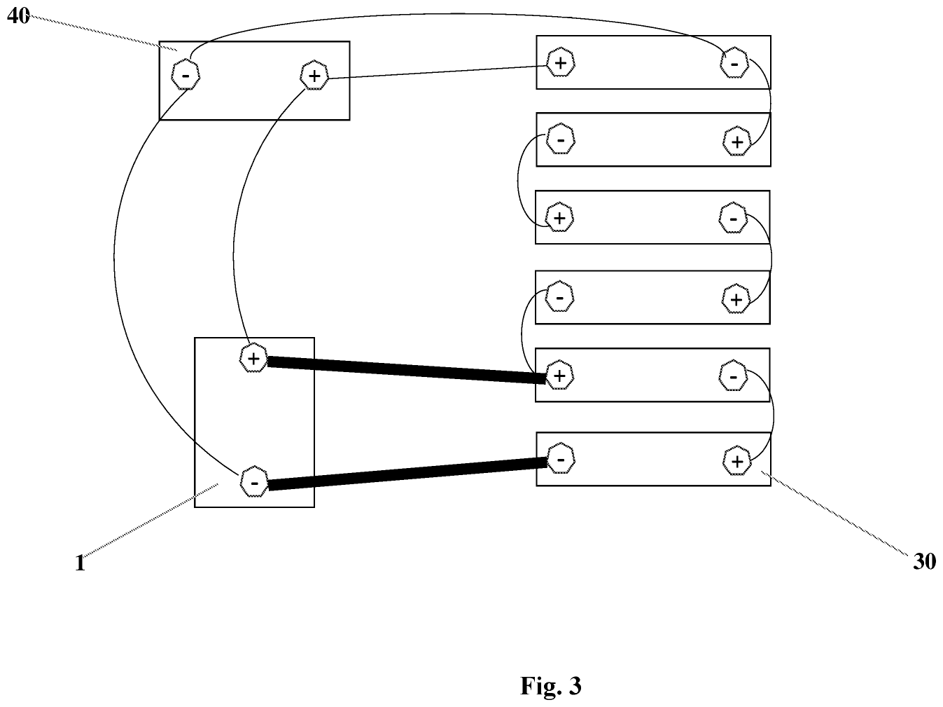

The proper size (diameter) of the cabling is dependent primarily upon the battery having the highest voltage output. For example, as shown in FIG. 3, if the primary battery is a standard 12-volt battery typically used for an electric golf cart, and there are six auxiliary 12-volt batteries, the series cabling for the auxiliary batteries ideally should be approximately ½ inch in diameter. The same goes for the cabling between the inverter and the respective auxiliary battery, and the cabling between the inverter and the primary battery. However, the cabling between the primary battery and the respective auxiliary battery ideally should be at least about 1.0 inch in diameter. The preferred diameter of cabling increases along with the power output of the battery having the highest output.

The system may operate independent of (or in conjunction with) an alternator, or it may replace an alternator.

FIG. 1 is a schematic sketch of a representative sample of the disclosed system, such as for a Club Car Precedent 4-seat golf cart or for a Polaris GEM e6 shuttle vehicle. The OEM components and their cabling connections are shown in dashed lining. The components added for the energy management system are shown in solid lining. The electric motor is powered by the plurality of batteries. The regen energy generated by the motor flows to the inverter for conversion processing en route back to the batteries, replenishing them to a much greater extent than merely returning the current directly from the motor. If the vehicle is already equipped with an OEM controller, the regen energy may flow through it before flowing to the inverter for conversion processing en route back to the batteries.

One general embodiment of the energy management system comprises (includes) an apparatus (essentially cabling and a supplemental inverter) working in conjunction with a vehicle's OEM energy utilization infrastructure, for increasing the life of the battery. Such infrastructure may include a battery (1) accepting electrical input and providing output to an OEM controller (20) accepting input and providing output after converting the electrical current to that acceptable to an electric motor (20). The motor typically causes movement of an electric vehicle and provides output after generating regen energy for routing to the battery via the OEM controller. The apparatus is essentially incorporated into (and extends) the electrical circuitry of the battery and the OEM controller and the motor, and may include:
(a) a supplemental inverter (40) accepting electrical input and providing output acceptable by the battery;
(b) a regen transmission cable (25) accepting output from the OEM controller and transporting it for input into the supplemental inverter (40); and
(c) an inverter transmission cable (45) accepting output from the supplemental inverter (40) and transporting it for input into the battery.
   The regen energy produced by the motor flows through the regen transmission cable (25) into and through the supplemental inverter (40), then flows through the inverter transmission cable (45) and into the battery (1).

In one embodiment, the OEM controller provides AC regen energy to the regen transmission cable and to the supplemental inverter. The OEM controller may also provide additional processing of electricity, such as converting high voltage DC regen energy to lower voltage DC electricity.

In a more particular embodiment, for a DC motor powered by a primary battery that may include a plurality of batteries interconnected as shown in FIG. 1:
(a) each of said battery connections includes a 2.0 gauge cable;
(b) the regen transmission cable and the inverter transmission cable each include a 2.0 gauge cable; and
(c) the supplemental inverter may include a 6 kW inverter converting AC regen energy supplied by the OEM controller into DC regen energy.

FIG. 2 is a schematic sketch of another representative sample of the disclosed system for a Chevrolet Bolt electric passenger vehicle. The OEM electrical utilization components and their cabling connections are shown in dashed lining. The components added for the energy management system are shown in solid lining. The Chevy Bolt has four major components relevant to the energy management system disclosed herein: (1) the single power inverter module (“SPIM”), (2) high power distribution module (“HPDM”), (3) onboard charging module (“OBCM”) and (4) the DC-to-DC converter. The OBCM converts AC energy from external sources into DC energy, for charging the battery. The HPDM's main functions are to send energy to the SPIM, air conditioner and heater. The SPIM's main function is to convert the high voltage DC power obtained from the HPDM into AC electricity to run the electric motor; it also receives energy from the onboard charger, that is converted to high voltage DC to charge the high voltage battery. The DC-to-DC converter will convert high voltage DC to low voltage DC and vice versa. (Other vehicles besides the Chevrolet Bolt have the same or similar components.) The SPIM, HPDM and DC-to-DC converter are included in the OEM controller described herein.

One existing cable from the traction battery connects to the vehicle's OEM controller, for supplying converted energy to the motor. Regen energy generated by the motor is transported through existing cabling to the OEM controller, then routed by a regen transmission cable to a supplemental inverter; energy from the traction battery is also routed to the supplemental inverter. Alternatively, both the OEM controller and the traction battery may route energy to a junction box, which then routes the energy to the supplemental inverter. (Given the voltage output of the traction battery, if any adjustment to the thickness of the cabling is necessary or prudent, it may easily be accomplished at the juncture box.) The converted energy then flows from the supplemental inverter through the inverter transmission cable to the battery, either directly or through the OEM controller. This replenishes the primary battery to a much greater extent than merely returning the regen energy to the battery as done without the energy management system.

As shown in FIG. 2, if the existing energy utilization infrastructure includes an auxiliary battery (30) or a plurality of auxiliary batteries, for powering non-motor electrical needs (for example), another embodiment of the apparatus may include:
(a) a supplemental inverter (40) accepting electrical input and providing DC output acceptable by the auxiliary battery;
(b) a regen transmission cable (25) accepting output from the OEM controller (20) and transporting it for input into the supplemental inverter (40); and
(c) an inverter transmission cable (45) accepting output from the supplemental inverter (40) and transporting it for input into the auxiliary battery (30).

The regen energy flows from the OEM controller (20) through the regen transmission cable (25) into and through the supplemental inverter (40), then flows through the inverter transmission cable (45) into the auxiliary battery (30), then flows through the auxiliary battery transmission cable (35) into the OEM controller (20), then flows into the battery (1). Some vehicles have OEM electrical utilization infrastructure including a DC-to-DC converter for converting high voltage electricity into to lower voltage electricity en route to the auxiliary battery; after the OEM controller, for example. For the disclosed energy management system, a DC-to-DC converter may be that which is positioned along the circuitry between the primary battery and the auxiliary battery if conversion from low voltage to high voltage (or vice versa) is desired or necessary before delivering processed regen energy from the auxiliary battery to the primary battery. That OEM DC-to-DC converter may be dual directional, also converting high voltage DC output from the primary battery into lower voltage electricity for input into the auxiliary battery.

The apparatus may include a primary battery transmission cable (5) accepting output from the battery (1) and transporting it for input into the supplemental inverter (40).

The apparatus further may include a junction box (50) accepting electrical input and providing output, wherein the regen transmission cable (25) instead transports the output of the OEM controller (25) for input into the junction box (50), and further may include a junction box transmission cable (55) accepting the output of the junction box (50) and transporting it for input into the supplemental inverter (40). The battery transmission cable (5) instead may transport the battery output for input into the junction box (50).

In a more particular embodiment, for an AC motor powered by a primary battery having about 400 volts:
(a) the regen transmission cable and the battery transmission cable and the inverter transmission cable each include a 6.0 gauge cable; and
(b) the supplemental inverter may include a 10 kW inverter converting AC electricity to DC electricity.

In another embodiment for an AC motor powered by a primary battery having fewer than 400 volts, the supplemental inverter may include a 6 kW inverter.

As shown in FIG. 3, in one embodiment the auxiliary batteries are each connected in modified “series”, with each's positive terminal connected by conductive cabling to the negative terminal of one other auxiliary battery, and each's negative terminal being connected by conductive cabling to the positive terminal of a different auxiliary battery. The positive terminal of the primary battery is connected by conductive cabling to the positive terminal of one of the auxiliary batteries, and to the positive terminal of the inverter by separate conductive cabling. The negative terminal of the primary battery is connected by conductive cabling to the negative terminal of the same auxiliary battery, and to the negative terminal of the inverter by separate conductive cabling. The positive terminal of the inverter is also connected by conductive cabling to the positive terminal of a different auxiliary battery, and the negative terminal of the inverter is also connected by conductive cabling to the negative terminal of that same auxiliary battery.

Also claimed is a method for increasing the life of a battery, accomplished using the apparatus disclosed herein. The method essentially includes routing regen energy through a supplemental inverter before being routed to the battery, with or without the junction box and/or the specialized cabling (and any configuration of connections) disclose above. Additionally, the method may include the other regen energy processing steps described above, including (without limitation) addition of primary battery electricity and electricity from the OEM controller, in the supplemental inverter; and conversion of regen energy by the OEM controller.

### Example 1

One embodiment of the system was tested in an electric-powered commercial Class 1 delivery cargo van manufactured by Mullen Automotive, with no energy-saving modifications. The standard model of these vehicles In the initial test with an EPA-certified dynamometer run by a disinterested and reputable third party, the vehicle's energy (battery) consumption was charted with the vehicle's wheels moving at speeds between 44 and 46 miles per hour with continuous headlights, continuous brake lights, continuous heater streaming, and continuous windshield wipers running. The battery was completely discharged after 5 hours and 37 minutes of such running. The same vehicle was then modified and fitted with the energy-saving system described herein, and tested under virtually the same conditions. After running 5 hours and 37 minutes at speeds within the same range as the initial test, the vehicle's battery had 44.0% of charge remaining.

### Example 2

Two similar embodiments of the system were tested by another independent and reputable testing company using a dynamometer, each installed on the same vehicle at different times. A 2020 Chevrolet Bolt all-electric vehicle was fitted with one version of the system and tested once, then the same vehicle was fitted with a similar version of the system and tested once under virtually the same conditions. Each time, the vehicle had its battery fully charged while all practical power (e.g., radio, headlights, brake lights, heater streaming, and windshield wipers, etc.) was turned off; the vehicle was then turned on and put in high drive mode using the cruise control set at 40 miles per hour, then all practical power was turned on. The results of those tests were compared to the published EPA-estimated electric range of 259 miles obtained from the webpage found at www.chevrolet.com/electric/bolt-ev, after which the battery was fully depleted; the footnote accompanying that electric range estimate states: “On a full charge. Actual range may vary based on several factors, including ambient temperature, terrain, battery age and condition, loading, and how you use and maintain your vehicle.” By contrast, for the first run of the vehicle having one embodiment of the disclosed apparatus, the Chevy Bolt had 37.6% of battery life remaining after “traveling” 269 miles. Similarly, for the second run of the vehicle having a slightly different embodiment of the disclosed apparatus, it had 38.8% of its battery charge remaining after traveling 269 miles. Neither test run resulted in any overheating or heat-related shutdowns. The complete results of the two vehicle tests are summarized in the following table.

| | | mileage | mileage | | | |
|---|---|---|---|---|---|---|
| | | traveled | traveled | | battery | HEV |
| | total test | (from road | (from | percentage | energy | BATT V |
| | time | load | vehicle | of battery | hours used | Voltage |
| | (hr:min:sec) | simulation | info. center | life left | (KWh) | (V) |
| Run 1 | 06:47:31 | 270.415 | 269.0 | 37.6 | 40.2 | 346.83 |
| Run 2 | 06:47:07 | 270.436 | 269.0 | 38.8 | 41.0 | 346.83 |

### Example 3

Another embodiment of the system was similarly tested in an electric-powered Club Car Precedent golf cart. The standard model has a range of up to 150 miles per charge, and a maximum speed of 19 miles per hour. If it traveled 150 miles at 10 mph, the battery ran 15 hours before full depletion; if it traveled 150 miles at 19 mph, the battery ran for 7.89 hours. By contrast, for the battery life test involving the energy management system, the vehicle was prepared for testing by raising the front to allow the drive wheels to spin freely (without touching the ground). With the vehicle batteries fully charged, the vehicle ran with the accelerator pedal fully depressed towards the floor, in the “FWD” drive mode. The vehicle ran for 1,357 minutes (22.62 hours) before the battery was fully discharged. No visible damage from overheating was noted on the vehicle.

Although the present disclosure and its advantages have been described in detail, it should be understood that various changes, substitutions and alterations can be made herein without departing from the spirit and scope of the design as defined by the appended claims. The scope of the present application is not intended to be limited to the particular embodiments of the process, machine, manufacture, composition of matter, means, methods and/or steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. The scope of the present application is not intended to be limited to the particular embodiments of the process, machine, manufacture, composition of matter, means, methods and steps described in the specification.

While a preferred embodiment of the present invention has been described, it should be understood that various changes, adaptations and modifications may be made therein without departing from the spirit of the invention. Changes may be made in details, particularly in matters of shape, size, material, and arrangement of parts without exceeding the scope of the invention.

While the forms of apparatus herein described constitute preferred embodiments of the invention, it is to be understood that the invention is not limited to these precise forms of apparatus, and that changes may be made therein without departing from the scope and spirit of the invention as defined in the appended claims.

Those skilled in the art will recognize improvements and modification to the preferred embodiments of the present disclosure. All such improvements and modifications are considered within the scope of the concepts disclosed herein and the claims that follow.

I claim:

1. An apparatus for increasing the life of an (unclaimed) battery accepting electrical input and providing output to an OEM controller accepting input and providing output after converting the electrical current to that acceptable to an (unclaimed) electric motor causing movement of an (unclaimed) electric vehicle and providing output after generating (unclaimed) regen energy for routing to the battery via the OEM controller, said apparatus being incorporated into and extending the electrical circuitry of the battery and the OEM controller and the motor, and comprising:
(a) a supplemental inverter accepting electrical input and providing output acceptable by the battery;
(b) a regen transmission cable accepting output from the OEM controller and transporting it for input into the supplemental inverter; and
(c) an inverter transmission cable accepting output from the supplemental inverter and transporting it for input into the battery;
wherein, regen energy produced by the motor flows through the regen transmission cable into and through the supplemental inverter, then flows through the inverter transmission cable and into the battery.

2. The apparatus described in claim 1, said OEM controller providing AC regen energy to the regen transmission cable and to the supplemental inverter.

3. The apparatus described in claim 1, the motor being a DC motor and the battery comprises a plurality of batteries interconnected as shown in FIG. 1, wherein:
(a) each of said battery connections includes a 2.0 gauge cable;
(b) the regen transmission cable and the inverter transmission cable each include a 2.0 gauge cable; and
(c) the supplemental inverter comprises a 6 kW inverter converting AC regen energy supplied by the OEM controller into DC regen energy.

4. An apparatus for increasing the life of an (unclaimed) battery accepting electrical input and providing output to an OEM controller accepting electrical input and providing output after converting the electrical current to that acceptable to an (unclaimed) electric motor causing movement of an (unclaimed) electric vehicle and providing output after generating (unclaimed) regen energy, the vehicle also having an auxiliary battery accepting electrical input and providing output to an auxiliary battery transmission cable connected to the OEM controller and routing said output to the battery, said apparatus being incorporated into and extending the electrical circuitry of the battery and OEM controller and motor and auxiliary battery, and comprising:
(a) a supplemental inverter accepting electrical input and providing DC output acceptable by the auxiliary battery;
(b) a regen transmission cable accepting output from the OEM controller and transporting it for input into the supplemental inverter; and
(c) an inverter transmission cable accepting output from the supplemental inverter and transporting it for input into the auxiliary battery;
wherein, regen energy flows from the OEM controller through the regen transmission cable into and through the supplemental inverter, then flows through the inverter transmission cable into the auxiliary battery, then flows through the auxiliary battery transmission cable into the OEM controller, then flows into the battery.

5. The apparatus described in claim 4, further comprising a primary battery transmission cable accepting output from the battery and transporting it for input into the supplemental inverter.

6. The apparatus described in claim 5, further comprising a junction box accepting electrical input and providing output, wherein the regen transmission cable instead transports the output of the OEM controller for input into the junction box, and further comprising a junction box transmission cable accepting the output of the junction box and transporting it for input into the supplemental inverter.

7. The apparatus described in claim 6, wherein the battery transmission cable instead transports the battery output for input into the junction box.

8. The apparatus described in claim 4, said OEM controller providing AC regen energy to the regen transmission cable.

9. The apparatus described in claim 4, the motor being an AC motor, wherein:
(a) the regen transmission cable and the battery transmission cable and the inverter transmission cable each include a 6.0 gauge cable; and
(b) the supplemental inverter comprises a 10 kW inverter converting AC electricity to DC electricity.

10. The apparatus described in claim 4, the motor being an AC motor, wherein:
(a) the regen transmission cable and the battery transmission cable and the inverter transmission cable each include a 6.0 gauge cable; and
(b) the supplemental inverter comprises a 6 kW inverter converting AC electricity to DC electricity.

11. A method for increasing the life of an (unclaimed) battery accepting electrical input and providing output to an OEM controller accepting electrical input and providing output after converting the electrical current to that acceptable to an (unclaimed) electric motor causing movement of an (unclaimed) electric vehicle and providing output after generating (unclaimed) regen energy, the vehicle also having an auxiliary battery accepting electrical input and providing output to an auxiliary battery transmission cable connected to the OEM controller and routing said output to the battery, said method comprising routing regen energy through a supplemental inverter before being routed to the battery.

12. A method described in claim 11, comprising the regen energy processing steps described in claim 4 hereinabove.
